(19) United States
(12) Patent Application Publication
(10) Pub. No.: US 2025/0314266 A1
(43) Pub. Date: Oct. 9, 2025

(54) BEARING SHELL FOR A BALL JOINT, BALL JOINT AND CHASSIS COMPONENT WITH SUCH A BEARING SHELL AND METHOD FOR MANUFACTURING THE BEARING SHELL

(71) Applicant: ZF Friedrichshafen AG, Friedrichshafen (DE)

(72) Inventor: Benjamin ZIEBART, Wallenhorst (DE)

(73) Assignee: ZF Friedrichshafen AG, Friedrichshafen (DE)

(21) Appl. No.: 19/169,484

(22) Filed: Apr. 3, 2025

(30) Foreign Application Priority Data
Apr. 9, 2024 (DE) 10 2024 203 233.6

(51) Int. Cl. F16C 11/06

(52) U.S. Cl. CPC F16C 11/0628

(57) ABSTRACT

A bearing shell (2) for a ball joint (1) includes a shell component (11) made from a first material, such that the shell component (11) has a ball segment shaped receiving space (6) into which a joint ball (4) is fitted and can swivel. An inner side (12) of the shell component (11) is coated with a second material to form a low-friction layer (13). To improve the sliding friction properties between the joint ball (4) and the bearing shell (2) and to reduce the friction between them, the bearing shell (2) is characterized in that the second material is parylene.

### RELATED APPLICATIONS

This application claims the benefit of and right of priority under 35 U.S.C. § 119 to German Patent Application no. 10 2024 203 233.6, filed on 9 Apr. 2024, the contents of which are incorporated herein by reference in its entirety.

### FIELD OF THE DISCLOSURE

The invention relates to a bearing shell for a ball joint and to a shell component made from a first material, such that the shell component forms a ball segment shaped receiving space into which a joint ball is fitted and can swivel, and such that an inside of the shell component has a layer of a second material which forms a low-friction layer. Furthermore, the invention relates to a ball joint with such a bearing shell and to a chassis component with such a ball joint. Finally, the invention relates to a method for manufacturing such a bearing shell.

### BACKGROUND

A bearing shell of this type and a ball joint with such a bearing shell are known from DE 10 2010 037 586 A1. In that case the second material is or contains zinc. Likewise, it is known therefrom that a lubricant is used in the ball joint to reduce the friction between the joint ball and the bearing shell.

In particular, in the case of a ball joint in a chassis of a vehicle, for example, besides the hydrodynamic sliding friction, mixed friction and solid-body friction also take place. During operation, especially during slow movements such as direction changes, the movement of the joint ball relative to the bearing shell can result in undesired friction effects, in particular breakaway effects and/or stick-slip effects. Such undesired friction effects can be attributed to the solid-body friction itself and to the proportion of solid-body friction in the mixed friction between the joint ball and the bearing shell. Consequently, it is desirable that besides the use of a friction-reducing lubricant, the material pairing of the friction partners, in this case the joint ball and the bearing shell, should have as low as possible a coefficient of friction between them.

### SUMMARY

Starting from there, the purpose of the present invention is to develop further a bearing shell and/or a ball joint and/or a chassis component and/or a method of the type mentioned at the start, in such manner that the sliding properties between the joint ball and the bearing shell are improved and the friction is reduced. In particular, the bearing shell should on the one hand have high strength and should resist pressure well, and on the other hand it should be characterized by improved sliding properties with reduced friction coefficients. Preferably, an alternative embodiment should be provided.

The objectives of the invention are achieved with a bearing shell, and/or with a ball joint, and/or with a chassis component, and/or by means of a method as disclosed herein. Preferred further developments of the invention emerge from the present disclosure.

The bearing shell is designed for a ball joint. In particular, the ball joint is designed to be used in a chassis component and/or in a chassis of a vehicle. The bearing shell comprised a shell component made from a first material. Preferably, the shell component defines a contour or configuration of the bearing shell. In particular, the bearing shell is formed from a single shell component. The shell component forms a ball segment shaped receiving space. The ball segment shaped receiving space is designed to receive a joint ball in such manner that it can swivel. The shell component has an inside. In particular the inside, at least in part, is spherical and/or in the form of a hollow ball segment in order to create the ball segment shaped receiving space. The inside of the shell component has a coating of a second material in order to form a low-friction layer. In particular, by virtue of the second material, a sliding layer is formed on the inside of the shell component Preferably, the whole of the inside is covered by the sliding layer made of the second material. In particular, the inside of the shell component has a single layer, and that layer is made of the second material, forming the sliding layer. According to the invention, the second material is parylene.

In this case it is advantageous that thanks to the formation of the low-friction layer from parylene the friction properties of the bearing shell are improved. In that way the friction between the bearing shell and the joint ball can be reduced. In particular, the use of parylene makes it possible to use particularly thin low-friction layers.

In a further embodiment, the parylene low-friction layer has a thickness of less that 30 μm, less than 20 μm, or less than 10 μm. Preferably, the parylene low-friction layer has a thickness of less than 5 μm, less than 2 μm, or less that 1 μm.

Preferably, the second material consists of fluorinated parylene. In particular, in each parylene molecule at least one or more hydrogen atoms are replaced by fluorine atoms. The use of parylene with or containing fluorine enables the friction between the bearing shell and the joint ball to be reduced still further.

The parylene low-friction layer can be applied onto the inside of the shell component by chemical gas-phase deposition. In that way a low-friction layer of parylene with a small thickness can be produced, which at the same time can be applied very uniformly onto the inside of the shell component.

Preferably, the shell component is coated completely with the second material, parylene. In that way, all the surfaces of the shell component, in particular also an outside of the shell component facing away from the inside, is coated with the second material, parylene. Although the low-friction parylene layer is only required on the inside of the shell component, the production of the low-friction layer is simplified and made cheaper by coating the shell component completely.

According to a further development, the first material, from which the shell component is made, is a plastic material. The plastic material can be unreinforced or reinforced. A reinforced plastic material can contain fiber reinforcement. Preferably, the first material is a POM (polyoxymethylene) plastic. Thus, by means of the first material, a shell component can be produced, which is strong enough and/or sufficiently resistant to pressure. At the same time, thanks to the low-friction parylene layer, better friction properties can be obtained.

Alternatively, the first material or plastic material of the shell component can be PEEK (polyetheretherketone), PK (polyketone), PBT (polybutyleneterephthalate), PEI (polyetherimide), PPA (polyphthalamide), PA (polyamide), or PPS (polyphenylenesulfide).

A ball joint with a bearing shell according to the invention is particularly advantageous. In particular the ball joint is designed for a chassis component and/or for a chassis of a vehicle. The ball joint has an inner joint portion. The inner joint portion contains a joint ball, the joint ball being accommodated and/or fitted into the receiving space of the bearing shell in such manner that it can swivel. A surface of the joint ball is at least partially in contact with the parylene low-friction layer.

The ball joint can be in the form of a ball-and-pin joint or a ball-and-sleeve joint. In particular the inside of the joint is a ball pin or a ball sleeve. The inside of the joint can have at least one joint pin, which extends away from the joint ball. In particular the inner portion of the joint is made of metal.

In automotive engineering, ball joints are used in numerous ways. Particularly in the chassis, ball joints serve to articulate chassis components such as steering components, wheel carriers, track-rods, or the like to one another, or to a control arm or to the vehicle body or an axle carrier fixed thereto.

The ball joint can have a joint housing. In particular, the joint housing is made open on at least one side. Preferably, the joint housing has a bousing recess. In particular, the bearing shell is fixed into the housing recess. The joint ball of the inner joint portion is fitted into the housing recess or the bearing shell in such manner that it can swivel relative to the joint housing. In particular, the at least one joint pin of the inner joint portion projects out of an opening of the bearing shell and/or the joint housing. The joint housing can be made of metal or a plastic.

According to a further development, the lubricant is located between the surface of the joint ball and the low-friction parylene layer. This enables hydrodynamic sliding friction and/or mixed friction. In particular, the lubricant is a grease or a mixture of at least two different greases.

Furthermore, a chassis component with a ball joint according to the invention is advantageous. The chassis component comprises in particular a first chassis component portion. The chassis component can comprise a second chassis component portion. The first chassis component portion can comprise or consist of a joint housing. In that case the bearing shell is fixed inside the joint housing. Thus, no relative movement or only restricted relative movement between the joint housing and the bearing shell is possible. In addition, the inner joint portion comprises at least one joint pin, which extends out of the bearing shell and the joint housing. In particular the joint pin is fixed to the second chassis component portion. Thus, the two chassis component portions are articulated to one another by way of the ball joint. Alternatively, the inner joint portion can be in the form of a track-rod, for example.

Finally, a method for producing a bearing shell according to the invention is advantageous, wherein the parylene low-friction layer is deposited onto the inside surface of the shell component by means of a chemical gas-phase deposition process. In particular the low-friction parylene layer is applied in the form of a gas or a plasma onto the inside of the shell component. This makes it possible to apply a low-friction layer which is at the same time as uniform and as thin as possible. In particular, the low-friction layer is applied with a thickness of less than 30 μm or less than 20 μm or less than 10 μm. Preferably, the parylene low-friction layer is applied with a thickness of less than 5 μm or less than 2 μm or less than 1 μm.

Specifically, the bearing shell made in accordance with the method according to the invention is a bearing shell according to the invention as described earlier. Preferably, the method explained in connection with the design features of the bearing shell according to the invention described herein is developed further. Moreover, the bearing shell described herein can be developed further in accordance with the design features explained in connection with the method.

### BRIEF DESCRIPTION OF THE DRAWING

Below, the invention is explained in greater detail with reference to the sole FIGURE In this, the same indexes denote the same, similar or functionally equivalent elements. The FIGURE shows:

FIG. 1: the sole FIGURE showing a sectioned side view of a ball joint according to the invention with a bearing shell according to the invention.

### DETAILED DESCRIPTION

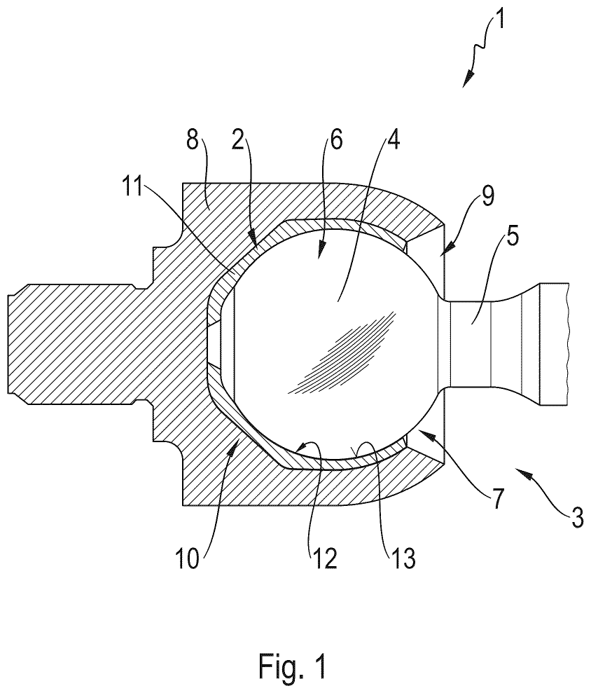

FIG. 1 shows a sectioned side view of a ball joint 1 according to the invention with a bearing shell 2 according to the invention. In this case, as an example the ball joint 1 is in the form of a ball-and-pin joint. The ball joint 1 has an inner joint portion 3. The inner joint portion 3 consists of a joint ball 4 and a joint pin 5 that extends away from the joint ball 4. In this embodiment the inner joint portion 3 is in the form of a ball pin.

The joint ball 3 is held or fitted into and can swivel in a receiving space 6 of the bearing shell 2. In this case the joint pin 5 of the inner joint portion 3 projects out of an opening 7 of the bearing shell 2.

The ball joint 1 has a joint housing 8. In this example embodiment, the joint housing 8 is in the form of an axial pot. The joint housing 8 is designed open on at least one side with an opening 9. In this case the openings 7 and 9 are orientated correspondingly relative to one another, so that the joint pin extends at the same time out of the opening 7 in the bearing shell and the opening 9 of the joint housing 8. The bearing shell 2 is fixed into a housing recess 10 of the joint housing 8.

The bearing shell 2 comprises a shell component 11 made of a first material. In this example embodiment the first material is a plastic material, namely POM (polyoxymethylene) plastic. Thus, from the first material a shell component 11 can be made, which is strong enough and sufficiently resistant to pressure.

The shell component 11 determines the design or shape of the bearing shell 2. The shell component 11 forms the ball-segment-shaped receiving space 6. Furthermore, the shell component 11 has an inner side 12. At least in part, the inner side 12 is of spherical or hollow spherical segment shape in order to form the ball-segment-shaped receiving space 6.

The inside 12 of the shell component 11 is coated with a second material to form a low-friction layer 13. The second material is parylene.

Thanks to the formation of the low-friction layer 13 from parylene the friction properties of the bearing shell 2 are improved. In that way the friction between the bearing shell 2 and the joint ball 4 is reduced. In this case the use of parylene makes it possible to produce a particularly thin low-friction layer 13.

In this example embodiment, the low-friction layer 13 of parylene has a thickness of less than 10 μm. The parylene low-friction layer 13 is applied to the inside surface 12 of the shell component 11 by means of a chemical gas-phase deposition process.

Moreover, at least partially (but not shown here) a lubricant is admitted between the surface of the joint ball 4 and the low-friction parylene layer 13, thereby enabling hydrodynamic sliding friction and/or mixed friction.

### INDEXES

1 Ball joint
2 Bearing shell
3 Inner portion of the joint
4 Joint ball
5 Joint pro
6 Receiving space
7 Opening (of the bearing shell)
8 Joint housing
9 Opening (of the joint housing)
10 Housing recess
11 Shell component
12 Inner side
13 Lon-friction layer

1. A bearing shell for a ball joint (1), comprising:
a shell component (11) made of a first material, such that the shell component (11) defines a ball segment shaped receiving space (6) into which a joint ball (4) fits and can swivel; and
an inside (12) of the shell component (11) is coated with a second material which forms a low-friction layer (13), wherein the second material comprises parylene.

2. The bearing shell according to claim 1, wherein the low-friction layer (13) has a thickness of less than 30 μm.

3. The bearing shell according to claim 1, wherein the low-friction layer (13) has a thickness of less than 5 μm.

4. The bearing shell according to claim 1, wherein the second material contains fluorinated parylene, wherein in each molecule of parylene one or more hydrogen atoms are replaced by fluorine atoms.

5. The bearing shell according to claim 1, wherein the low-friction layer (13) is applied onto the inside (12) of the shell component (11) by means of a chemical gas-phase deposition process, and/or the shell component (11) is coated completely with the second material parylene.

6. The bearing shell according to claim 1, wherein the first material is a thermoplastic.

7. A ball joint comprising:
the bearing shell (2) according to claim 1;
an inner joint portion (3) including a joint ball (4), wherein the joint ball (4) is fitted into and can swivel in the receiving space (6) of the bearing shell (2); and
a surface of the joint ball (4) is at least partially in contact with the parylene low-friction layer (13).

8. The ball joint according to claim 7, comprising a lubricant between at least part of the surface of the joint ball (4) and the low-friction layer (13), whereby hydrodynamic sliding friction and/or mixed friction takes place between the joint ball (4) and the bearing shell (2).

9. A chassis component comprising:
the ball joint (1) according to claim 7,
a chassis component with a joint housing (8), wherein the bearing shell (2) is fixed in the joint housing (8); and
wherein the inner portion (3) of the joint comprises at least one joint pin (5) which extends out of the bearing shell (2) and the joint housing (8).

10. A method for producing the bearing shell (2) in accordance with claim 1, wherein the parylene of the low-friction layer (13) is applied onto the inside (12) of the shell component (11) by means of a chemical gas-phase deposition process.

11. The bearing shell according to claim 1, wherein the low-friction layer (13) has a thickness of less than 20 μm.

12. The hearing shell according to claim 1, wherein the low-friction layer (13) has a thickness of less than 10 μm.

13. The bearing shell according to claim 6, wherein the thermoplastic is a POM (polyoxymethylene) plastic.
